(19) United States
(12) Patent Application Publication
(10) Pub. No.: US 2012/0311010 A1
(43) Pub. Date: Dec. 6, 2012

(54) MECHANISM FOR PEER-TO-PEER FILE SHARING BY INDIVIDUAL CLIENT NETWORKING APPLICATIONS

(76) Inventor: AMIT SHAH, Pune (IN)

(21) Appl. No.: 13/149,004

(22) Filed: May 31, 2011

(51) Int. Cl. G06F 15/16

(52) U.S. Cl. 709/201

(57) ABSTRACT

A mechanism for peer-to-peer file sharing by individual client networking applications is disclosed. A method of the invention includes sending to a server computing machine a request to access data by a networking application of a client computing machine; identifying to the server computing machine an ability of the client computing machine to seed data to peers of the client computing machine, receiving at the networking application a list of contact information of one or more peers of the client computing machine that have at least a portion of the requested data, selecting by the networking application one or more peers from the received list to download the data from, wherein the selection is prioritized based on a geographic proximity of the one or more peers to the client computing machine, and requesting by the networking application the content from the selected one or more peers.

### TECHNICAL FIELD

The embodiments of the invention relate generally to networking and, more specifically, relate to a mechanism for peer-to-peer file sharing by individual client networking applications.

### BACKGROUND

Each computer on the Internet can be used to seed part or a whole of a content file that is downloaded on that computer to other users on the Internet. Data that can be seeded includes web pages, downloaded files, etc. A main tracker remains on a main server of the seeding service provider with the original data. In this way, the canonical source of the data has control of what data gets served. For example, in the case of a web page getting updated, the tracker is updated automatically so that end users do not get stale data. One well-known provider of such a seeding service is BitTorrent™.

One problem with current seeding services, such as BitTorrent™, is the requirement to download a specific dedicated application from the service to enable use of the seeding service at a peer. For example, for BitTorrent™ a dedicated application such as Vuze™ or μTorrent™ is required on the peer to be able to download content using seeding. Another problem with the current seeding services is that they cannot be used for all types of different content that can be downloaded, such as email attachments.

For example, take a group of people in the same company and same location that frequently access email attachments. Moreover, assume that the servers hosting the email are in the United States, while the workers are in India. For any email attachment sent to the workers in India, the workers would have to download the attachment via international file transfer from the US server to the India location. International file transfer can be quite slow and onerous, while local file transfer is much faster. In the above example, the workers are constrained by an inability to take advantage of peer-to-peer file transfer for the email attachment as well as lack of built-in seeding support in the email client itself for the file transfer of the email attachment.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of a system for peer-to-peer file sharing by individual client networking applications according to an embodiment of the invention;

FIG. 2 is a flow diagram illustrating a method performed by a server for peer-to-peer file sharing by individual client networking applications according to an embodiment of the invention;

FIG. 3 is a flow diagram illustrating a method performed by a client for peer-to-peer file sharing by individual client networking applications according to an embodiment of the invention; and

FIG. 4 illustrates a block diagram of one embodiment of a computer system.

### DETAILED DESCRIPTION

Embodiments of the invention provide a mechanism for peer-to-peer file sharing by individual client networking applications. A method of embodiments of the invention includes sending to a server computing machine a request to access data by a networking application of a client computing machine; identifying to the server computing machine an ability of the client computing machine to seed data to peers of the client computing machine, receiving at the networking application a list of contact information of one or more peers of the client computing machine that have at least a portion of the requested data, selecting by the networking application one or more peers from the received list to download the data from, wherein the selection is prioritized based on a geographic proximity of the one or more peers to the client computing machine, and requesting by the networking application the content from the selected one or more peers.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “sending”, “receiving”, “attaching”, “forwarding”, “caching”, “identifying”, “selecting”, “requesting”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a machine readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the present invention is not described with reference to any particular programming language. It will be appreciated that a variety of programming languages may be used to implement the teachings of the invention as described herein.

The present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (non-propagating electrical, optical, or acoustical signals), etc.

Embodiments of the invention provide a mechanism for peer-to-peer file sharing by individual client networking applications. In particular, embodiments of the invention implement functionality in applications of peer clients, such as web browsers and email applications, to support the serving of downloaded content by the peer to other peers in close geographic proximity. When a first peer downloads content from a server, such as a video from a website, or an attachment from an email, this data is mirrored so that other individual users/peers in geographic proximity with the first peer can obtain the content from the first peer. The applications on the peer accessing the data act as the servers for the data that other users need.

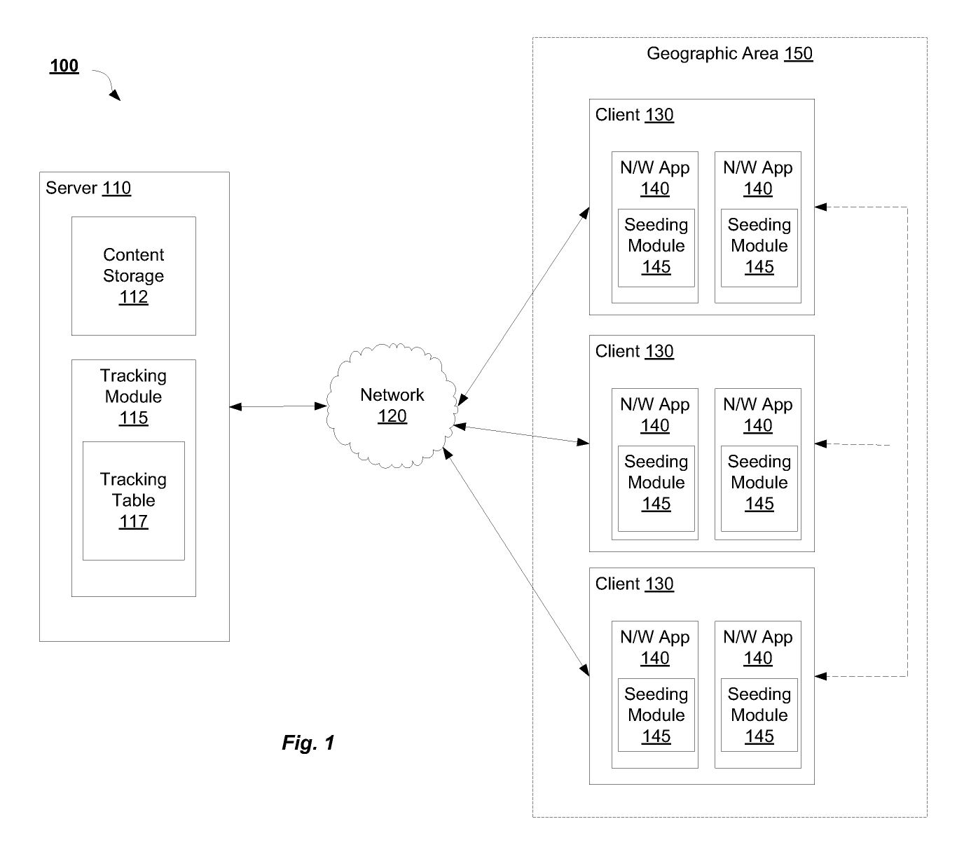

FIG. 1 is a block diagram of a system 100 for peer-to-peer file sharing by individual client networking applications according to an embodiment of the invention. System 100 includes a server 110 communicably coupled via network 120 to one or more clients 130. The network 120 may be a private network (e.g., a local area network (LAN), wide area network (WAN), intranet, etc.) or a public network (e.g., the Internet).

In one embodiment, server 110 is a server computing machine operable to provide content and services for one or more networking applications executed by one or more of clients 130. Clients 130 are computing machines executing applications for use by an end user (not shown). Networking applications 140 may include any type of application executed in software, hardware, firmware, or some combination thereof, which accesses content over a network connection. Some examples of networking applications 140 include, but are not limited to, web browsers, email applications, and real-time communication applications. Each client 130 may execute one or more different types of networking applications 140.

In embodiments of the invention, a client 130 is used to seed content to other clients 130 (also known as “peers”) when this content has already been downloaded by the sharing client 130. Content that can be shared includes web pages, downloaded videos and files, email attachments, etc. Embodiments of the invention eliminate the need for dedicated applications on clients 130 that enable the sharing and seeding of content, as the networking applications 140 themselves act as the server for the content that is shared with peers. To provide for the peer-to-peer file sharing and seeding of embodiments of the invention, the server 110 for a particular network application 140 includes the original source of data in its content storage 112 and a tracking mechanism 115.

In some embodiments, a single application on a peer may act as the ‘peer’ on behalf of multiple applications on a client, like a single program that seeds data instead of the browser, email program, and so on, all doing the same thing. In this case, the browser and the email program are modified in such a way to communicate with this central program to point it to the data that is to be seeded or downloaded. Agents on both of the original server and applications on the peer act together to provide the functionality for mirroring.

When a networking application 140 of a client 130 contacts server 110 to access content, the server 110 references its tracking mechanism 115 to determine if a peer of the client 130 has already downloaded the content. The tracking mechanism includes a tracking table 117 to keep information about the server's content and peers that have downloaded it. If no peers have the content, the server 110 provides the content to the client 130 directly. However, if the content has already been downloaded by a peer, the server 110 provides to the networking application 140 contact information for all of the available peers that have the content in their active cache. In one embodiment, the contact information is Internet Protocol (IP) addresses of the peers. This type of information can be given as a response to a client's request for a file.

For example, the following communications may take place:

Client--->Server: I want file abc.mp3

### Server--->Client: Here it is.

—or—
Client--->Server: I want file xyz.mp3
Server--->Client: Here is a list of peers which can give you that file.
The second response is a generic response type, which in the worst case will only include one peer (i.e., the server itself) if no one else has the file in their cache. The list of peers gets updated dynamically, so the client can see new peers while downloading, and the download can be sped up by simultaneously fetching the file from multiple sources. In one embodiment, the list of peers may be updated dynamically by the server pushing a new list of peers to all clients. However, this can be inefficient as the server will have to maintain state of all existing clients. Accordingly, in another embodiment, the clients keep polling servers after some timeout interval for a new list of peers. This timeout interval may be user-configurable, and, in some cases, may be several minutes or even hours.

In some embodiments, server 110 may only provide contact information of peers that are located in geographic proximity 150 to the client 130. The use of geographic proximity 150 also minimizes downloads from the server 110 to each geographic area 150 and reduces load time within a geographic area 150. In other embodiments, the server 110 provides a list of contact information of all possible peers to obtain content from, and the individual networking application 140 may determine which peers are geographically close. In one embodiment, geographic proximity may be determined based on the contact information. For example, existing tools that map the IP addresses to geographical locations may be utilized to provide a location of the peer, which may be compared against a current location of the client having the networking application. Another way would be to actually fetch some portion of data and measure the time it takes to fetch this data from multiple peers. This can be done to find out slow and fast connections within a specific geographic area, for example.

By utilizing a tracking mechanism 115 at the server 110 associated with the networking application and having the original content, the source of the content maintains control of what data gets served. For example, in the case of a web page getting updated, the tracking mechanism 115 at the web server 110 automatically updates its tracking table 117 to remove any references to peers holding the old data so that end users will not get stale data by downloading the content from a peer having the old data. Furthermore, security risks are limited as local files are not shared by a client 130; just files that get fetched from the Internet by the client 130 via the networking application 140 and its associated content server 110. In addition, a server 110 does not have to mirror all of its data across various data centers to ensure local delivery, as embodiments of the invention only mirror the data that gets fetched by individual users and then the networking applications 140 of the users act as the server for that data.

In embodiments of the invention, the tracking mechanism 115 may perform a variety of functions. The tracking mechanism 115 may keep track of active networking applications 140 of clients 130 connected to the network by maintaining this information in its tracking table 117. It may also use the tracking table 117 to keep track of networking applications 140 that already have an entire file, or some chunks of file, already downloaded and can pass on that data to other networking applications 140. To make this method secure, the tracking mechanism 115 stores hashes of the attachments/files that are served in its tracking table 117, along with contact information of the peers hosting that data. The tracking mechanism 115 may also include logic that can determine which networking applications 140 are in the same geographic proximity 150 (e.g., based on the IP addresses of the peers) to other networking applications 140 and pass of this information to the networking applications 140. In one embodiment, to reduce load on servers, clients can be made to announce their availability to servers, instead of servers fetching information from clients.

On the client 130 side, each networking application 140 includes functionality to enable the sharing and seeding of content accessed and downloaded by the networking application 140, as well as to access and download content from other peers for the networking application 140. This functionality may be implemented by a seeding mechanism 145 that may be an extension to the existing protocol of the networking application 140 or part of a new protocol altogether for the networking application 140. In embodiments of the invention, seeding mechanism 145 works with server 110 to identify the networking application 140 to the server 110 as capable of peer-to-peer file sharing and seeding. It can also receive the list of contact information from the server 110 and request the content from other peers. In some embodiments, seeding mechanism 145 may determine which peers are located in geographic proximity to the client 140 and select those peers for download purposes. In addition, seeding mechanism 145 may determine whether a speed of transfer of a current peer download is too slow and request a new peer connection for content download. Finally, seeding mechanism 145 may respond to requests from other peers to provide content already downloaded at client 130 by networking application 140 to those peers.

Embodiments of the invention do not limit the ways in which content may be shared for a networking application 140 between clients 130 (peers). In some embodiments, an entire file may be provided from one client 130 to another. Furthermore, it is not necessary that content be downloaded sequentially. A file of content may be divided into multiple chunks and each peer can serve any non-sequential portion of those chunks or the whole file of chunks. In other embodiments, a client 130 may access portions (chunks) of the content from two or more different clients 130. Tracking mechanism 115 may provide the information to seeding mechanism 145 of which peers have which portions of the content, and then seeding mechanism 145 can then obtain the content by any means determined most efficient In some embodiments, peers may communicate with each other to identify chunks they hold. This way, the server is not involved in making decisions as to which chunks are held by which peers. The server is always a peer, and will always have all of the chunks required for the file.

The server should only be required to keep minimal data, which is the list of peers for each particular file. The list of peers is typically IP addresses. The server can optionally store more information, such as each client's sharing ratio. The sharing ratio will clarify whether a particular client is a ‘good’ peer (i.e., they make content available to others), or a ‘bad’ peer (i.e., client only downloads, but never shares the downloaded data with others).

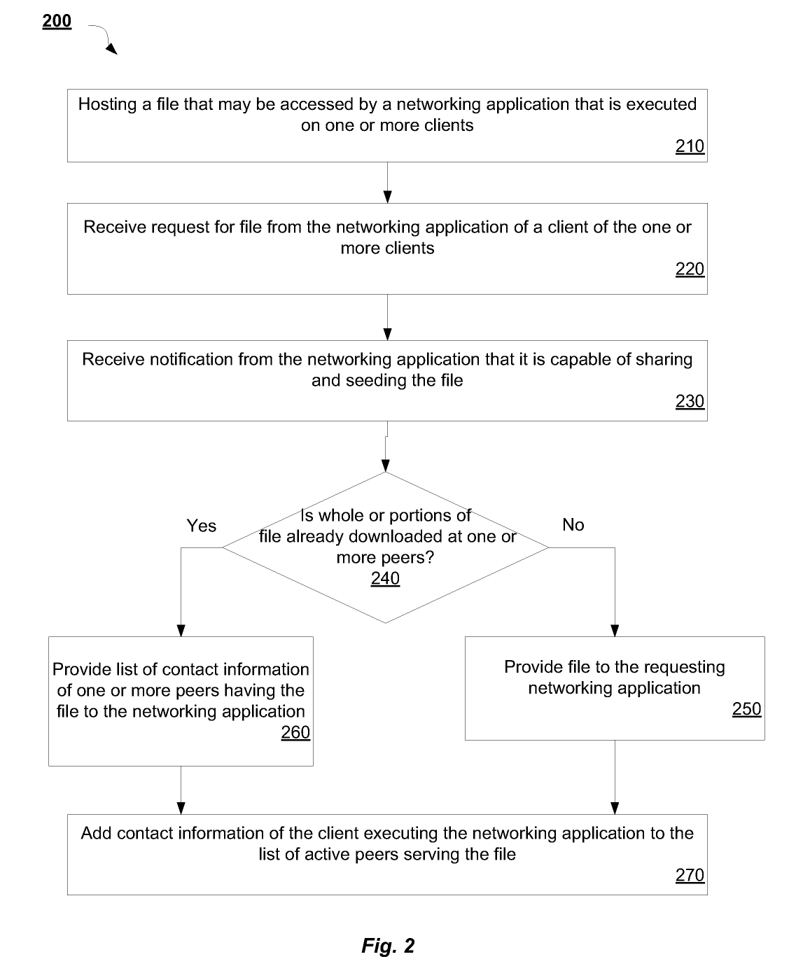

FIG. 2 is a flow diagram illustrating a method 200 performed by a server for peer-to-peer file sharing by individual client networking applications according to an embodiment of the invention. Method 200 may be performed by processing logic that may comprise hardware (e.g., circuitry, dedicated logic, programmable logic, microcode, etc.), software (such as instructions run on a processing device), firmware, or a combination thereof. In one embodiment, method 200 is performed by server 110 of FIG. 1.

Method 200 begins at block 210 where a server for a networking application hosts a file that can be accessed by the networking application. The networking application may be executing on one or more client machines that are communicably coupled to the server via a network. Then, at block 220, a request for the file is received from the networking application running on one of the client machines. In addition, at block 230, a notification is also received from the networking application that identifies the networking application as capable of sharing and seeding content for peers. In some embodiments, the server may further confirm that this notification is true by referencing a tracking mechanism at the server which tracks all peers capable of sharing and seeding content. In one embodiment, the networking application of the client may have registered with the server for this purpose at a previous time.

Subsequently, at decision block 240, the server determines whether the entire file or portions of the entire file are already downloaded at one or more peers of the client with the networking application by referencing a tracking mechanism of the server. In one embodiment, the server references the tracking mechanism to see if a hash of the file is indexed at the tracking mechanism. Other indexing options for the file at the tracking mechanism may also be utilized. If the server does not locate the file at the tracking mechanism at decision block 240, then method 200 continues to block 250 where the server provides the entire file to the requesting networking application. In one embodiment, the server may just announce a list of peers with just the server name being on the list.

On the other hand, if the server does locate the file at the tracking mechanism of the server at decision block 240, then method 200 proceeds to block 260 where the server provides a list of IP addresses of one or more peers having the file to the networking application. In one embodiment, the tracking mechanism maintains an active list of contact information of peers having the file. In one embodiment, the contact information is an IP address. This list of contact information of peers can be found at the entry located at the hash of the file in a tracking table of the tracking mechanism. In one embodiment, the server provides a list of contact information for only those peers that are geographically proximate to the client of the requesting networking application.

Finally, at block 270, the contact information of the client executing the networking application is added to the list of active peers hosting the file. In one embodiment, this means adding the contact information of the client and the portions of the file the client now stores to an entry indexed by a hash of the file in the tracking table of the server's tracking mechanism.

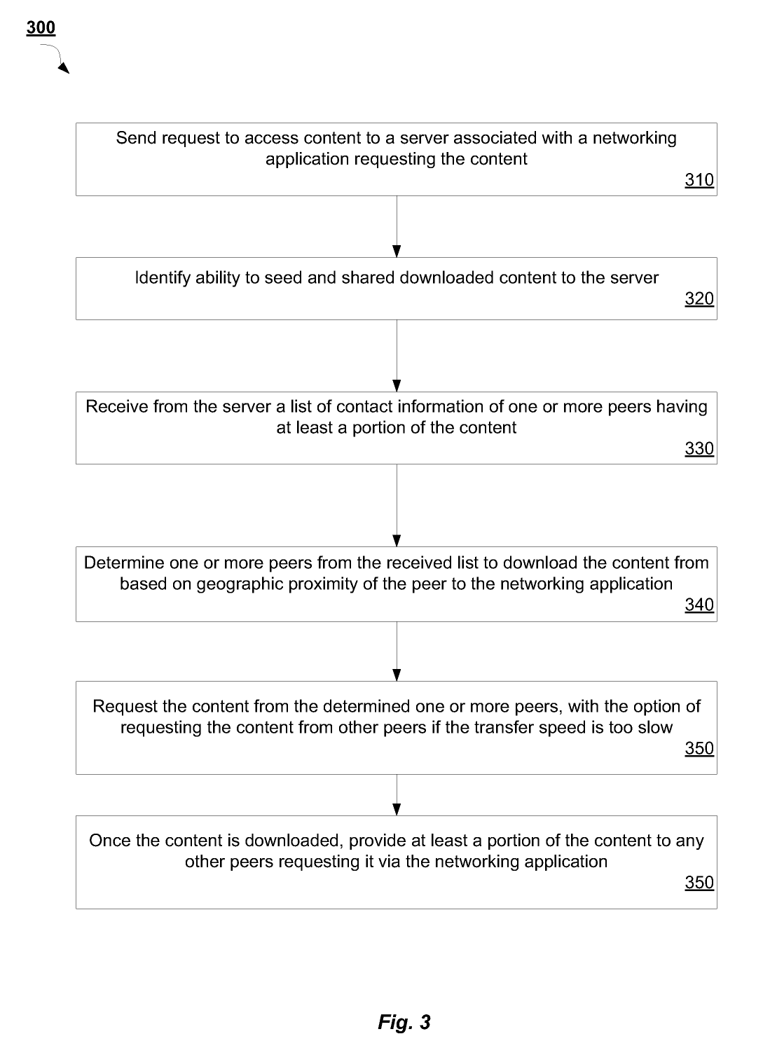

FIG. 3 is a flow diagram illustrating a method 300 performed by a client for peer-to-peer file sharing by individual client networking applications according to an embodiment of the invention. Method 300 may be performed by processing logic that may comprise hardware (e.g., circuitry, dedicated logic, programmable logic, microcode, etc.), software (such as instructions run on a processing device), firmware, or a combination thereof. In one embodiment, method 300 is performed by client 130 of FIG. 1.

Method 300 begins at block 310 where a request to access content is sent to a server associated with a networking application of the client. The networking application is the component that is requesting the content. Then, at block 320, the networking application of the client identifies to the server the ability of the client to seed and share downloaded content. In one embodiment, this can be done by using new request and response codes. For example, a client asks for a file from a web server with the following command: Fetch/index.html. In this case, if the file exists, the server replies with a positive status and then sends the file.

In the case of the file not existing, the server replies with a ‘file not found’ error message, or the 404 error code. The client, when it sees a 404 response, knows there is no such file. Similarly, new request and response codes will have to be devised for client-server communication that mean ‘you can give me a list of peers’, ‘this is the list of peers’, and so on. The client can initially learn of the server's ability to provide a list of peers by requesting the list of commands a server supports, or by sending a ‘I can be a peer in the delivery network’ request. If the server ignores it or replies with an error, the client should assume the server does not understand it. If the server replies with a positive response, the client can take part in the new protocol.

At block 330, a list of contact information for one or more peers is sent to the networking application from the server. The contact information is for one or more peers of the client that have at least a portion of the requested content. In one embodiment, the contact information may be IP addresses of the peers. Using this list, the networking application determines one or more peers to download the content from based on a geographic proximity of the peers to the client at block 340. In one embodiment, geographic proximity may be determined based on the contact information. For example, existing tools that map IP addresses to geographical locations may be utilized to provide a location of the peer, which may be compared against a current location of the client having the networking application.

Subsequently, at block 350, the networking application requests the content from the selected peers. In one embodiment, if the transfer speed from a selected peer is too slow, the networking application may close the connection and request the same content from a different peer. Lastly, at block 360, the networking application provides all content downloaded by the networking application to one or more other peers requesting the content via the networking application. Seeding of the content can start as soon as one chunk is downloaded by the client. Clients need not wait for the entire file to be downloaded to start seeding.

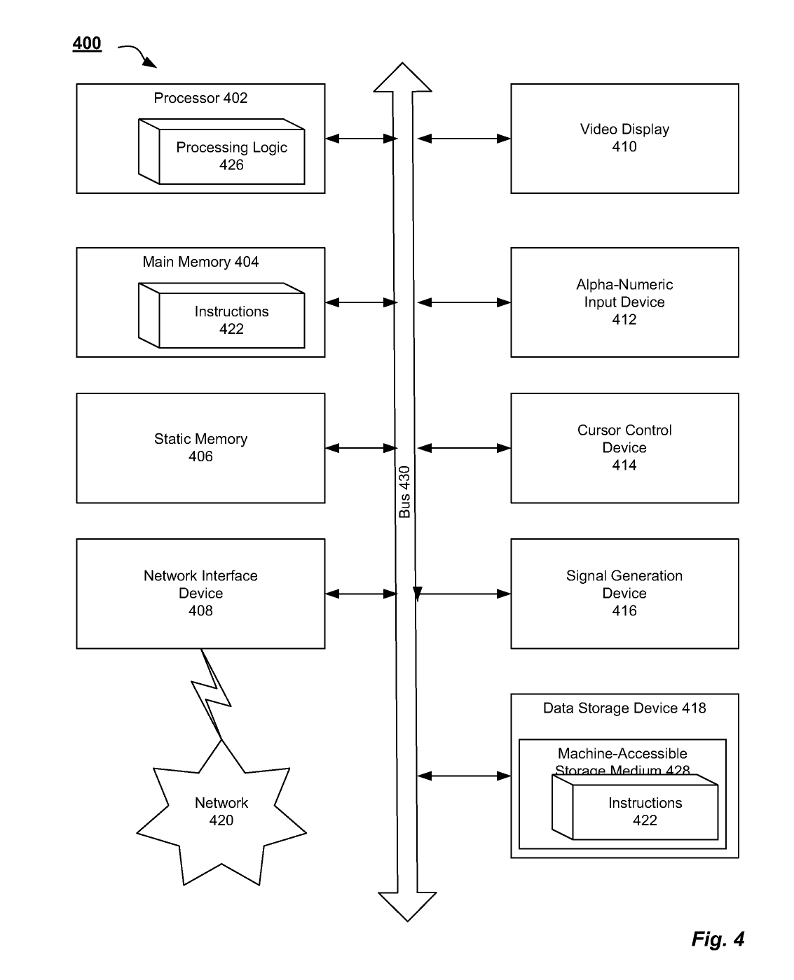

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) (such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. The processing device 402 is configured to execute the processing logic 426 for performing the operations and steps discussed herein.

The computer system 400 may further include a network interface device 408. The computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

The data storage device 418 may include a machine-accessible storage medium 428 on which is stored one or more set of instructions (e.g., software 422) embodying any one or more of the methodologies of functions described herein. For example, software 422 may store instructions to perform peer-to-peer file sharing by individual client networking applications by server 110 and clients 130 described with respect to FIG. 1. The software 422 may also reside, completely or at least partially, within the main memory 404 and/or within the processing device 402 during execution thereof by the computer system 400; the main memory 404 and the processing device 402 also constituting machine-accessible storage media. The software 422 may further be transmitted or received over a network 420 via the network interface device 408.

The machine-readable storage medium 428 may also be used to store instructions to perform methods 200 and 300 for peer-to-peer file sharing by individual client networking applications described with respect to FIGS. 2 and 3, and/or a software library containing methods that call the above applications. While the machine-accessible storage medium 428 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A computer-implemented method, comprising:
sending, by a networking application of a client computing machine to a server computing machine, a request to access data by a networking application of the client computing machine;
identifying, by the networking application to the server computing machine, an ability of the client computing machine to seed data to peers of the client computing machine;
receiving, by the networking application of the client computing machine, a list of contact information of one or more peers of the client computing machine that have at least a portion of the requested data;
selecting, by the networking application of the client computing machine, one or more peers from the received list to download the data from, wherein the selection is prioritized based on a geographic proximity of the one or more peers to the client computing machine; and
requesting, by the networking application of the client computing machine, the content from the selected one or more peers.

2. The method of claim 1, wherein the networking application comprises at least one of an electronic mail application, a web browser application, a real-time communication application, and a proxy server application.

3. The method of claim 1, wherein the contact information comprises Internet Protocol (IP) addresses of the one or more peers.

4. The method of claim 1, further comprising simultaneously receiving different chunks of the data from more than one of the selected peers.

5. The method of claim 1, further comprising seeding at least a portion of the data to the one or more peers if requested by a networking application of a peer.

6. The method of claim 1, wherein the networking application includes an extension of its protocol to handle requesting the data from and seeding the data to the one or more peers.

7. The method of claim 1, wherein the server computing machine is dedicated to serving data related to a plurality of networking applications that include the networking application of the client computing machine.

8. The method of claim 7, wherein the server computing machine includes a tracking module to track data served by the server computing machine to the plurality of networking applications and contact information of clients of the plurality of networking applications.

9. A system, comprising:
a memory;
a processing device communicably coupled to the memory; and
a networking application executed from the memory by the processor, the networking application configured to:
send to a server computing machine a request to access data;
identify to the server computing machine an ability of the system to seed data to peers of the client;
receive from the server computing machine a list of contact information of one or more peers of the system that have at least a portion of the requested data;
select one or more peers from the received list to download the data from, wherein the selection is prioritized based on a geographic proximity of the one or more peers to the system; and
request the content from the selected one or more peers.

10. The system of claim 9, wherein the networking application comprises at least one of an electronic mail application, a web browser application, a real-time communication application, and a proxy server application.

11. The system of claim 9, wherein the contact information comprises Internet Protocol (IP) addresses of the one or more peers.

12. The system of claim 9, wherein the networking application is further configured to simultaneously receive different chunks of the data from more than one of the selected peers.

13. The system of claim 9, wherein the networking application is further configured to seed at least a portion of the data to the one or more peers if requested by a networking application of a peer.

14. The system of claim 9, wherein the networking application includes an extension of its protocol to handle requesting the data from and seeding the data to the one or more peers.

15. The system of claim 9, wherein the server computing machine is dedicated to serving data related to a plurality of networking applications that include the networking application of the client computing machine and wherein the server computing machine includes a tracking module to track data served by the server computing machine to the plurality of networking applications and contact information of clients of the plurality of networking applications.

16. An article of manufacture comprising a machine-readable storage medium including data that, when accessed by a machine, cause the machine to perform operations comprising:
receiving, by a server computing machine serving data for a plurality of networking application, a request for data from a networking application of a client;
receiving, by the server computing machine, notification from the networking application of the ability of the networking application to seed data for peers;
determining, by the server computing machine, one or more peers of the client that are currently present on a network of the client;
sending, by the server computing machine, a list of contact information of the one or more peers that are present on the network to the networking application; and
adding, by the server computing machine, contact information of the client of the networking application to a list of active peers serving the data.

17. The article of manufacture of claim 16, wherein the networking application comprises at least one of an electronic mail application, a web browser application, a real-time communication application, and a proxy server application.

18. The article of manufacture of claim 16, wherein the contact information comprises Internet Protocol (IP) addresses of the one or more peers.

19. The article of manufacture of claim 16, wherein the server computing machine is dedicated to serving data related to a plurality of networking applications that include the networking application of the client computing machine.

20. The article of manufacture of claim 16, wherein the server computing machine includes a tracking module to track data served by the server computing machine to the plurality of networking applications and contact information of clients of the plurality of networking applications.
